(19) United States
(12) Patent Application Publication
(10) Pub. No.: US 2003/0185646 A1
(43) Pub. Date: Oct. 2, 2003

(54) Loose prevention pocket nut structure

(76) Inventor: Ming-Chong Chou, Taipei (TW)

Correspondence Address: Ming-Chong Chou, PO Box 82-144, Taipei, TW

(21) Appl. No.: 10/109,705

(22) Filed: Apr. 1, 2002

(51) Int. Cl. F16B 39/284

(52) U.S. Cl. 411/247

(57) ABSTRACT

A loose prevention pocket nut structure comprising a screw nut and a nut cap formed from a punched metal sheet, characterized in that the bottom edge at the circumference of the nut cap is provided with an engaging plate for directly combine with the top edge of the screw nut within a mold to proceed to a mounting process such that the nut cap and the screw nut are formed integrally as a loose prevention pocket nut structure, thereby the protruded engaging plate secures with the bolt after the bolt is positioned with the screw nut.

### BACKGROUND OF THE INVENTION

1. Technical Field of the Invention

The present invention relates to a loose prevention pocket nut structure, and in particular, to a nut cap with an engaging plate protruded from the bottom edge of the nut cap to form a loose prevention pocket nut structure.

2. Description of the Prior Art

FIGS. 7 and 8 show a conventional pocket nut structure, wherein the top external edge of the nut body 30 is welded to a nut cap 31 to form a pocket nut structure. However, there is no element on the nut structure to prevent the loosening of the nut cap body 30. In one type of loose prevention screw nut, one interior end of the nut is provided with a filler made from either a nylon ring or a steel disc. The nylon ring is a more commonly used filler as the manufacturing process is simple and the cost of manufacturing is lower. However, the nut body which is the nylon ring is not suitable in the welding process. The nylon ring may be broken. Thus, when it is manufactured to use as a pocket nut, the cap is covered until the bottom edge of the nut. As shown in ROC patent publication no. 155428, the cost of covering the nut is expensive and the rigidity of the covering is poor.

U.S. Pat. No. 4,993,902 relates to the manufacturing of a loose prevention nut. The plastic nylon ring 50 is appropriately extended and the external edge of the nut cap 72 is also made from plastic material so that a complete loose prevention nut structure is obtained. In this conventional nut, riveting process is used for mounting the nut cap and the screw nut body, however, the external appearance of the combination nut is rough, and coarse and in the process of riveting, the riveted end may be dislocated if the tip of the bolt is urged too deeply into the nut structure.

Thus, the present invention overcomes these and other shortcomings of the conventional art by providing for simple, low-cost loose prevention pocket nut structure. The present invention comprises a screw nut body and a nut cap formed from a metallic sheet by a punching process.

### SUMMARY OF THE INVENTION

Accordingly, it is an object of the present invention to provide a loose prevention pocket nut structure, comprising a screw nut and a nut cap formed from a punched metal sheet, characterized in that the bottom edge at the circumference of the nut cap is provided with an engaging plate for directly combine with the top edge of the screw nut within a mold to proceed to a mounting operation such that the nut cap and the screw nut are formed integrally as a loose prevention nut structure, thereby the protruded engaging plate secures with the bolt after the bolt is positioned with the screw nut.

Yet another object of the present invention is to provide a loose prevention pocket nut structure, wherein the nut structure can be conveniently manufactured by using automation process so that the cost of manufacturing is lower.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a loose prevention pocket nut structure of the present invention.

FIG. 2 is a perspective cross-sectional view of the loose prevention pocket nut structure of the present invention.

FIG. 3 shows a sectional view of the loose prevention pocket nut in combination with a bolt and a nut of the present invention.

FIG. 4 is a perspective cross-sectional view of another preferred embodiment of loose prevention pocket nut in accordance with the present invention.

FIG. 5 is a perspective exploded view of a loose prevention pocket nut structure having an external end plate along the circumferential edge of the nut structure in accordance with the present invention.

FIG. 6 is a perspective cross-sectional view of a loose prevention pocket nut structure in accordance with the present invention.

FIG. 7 is a perspective exploded view of a conventional metallic nut and cap structure.

FIG. 8 is a sectional view of the conventional metallic nut structure in combination with a bolt and a screw nut.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

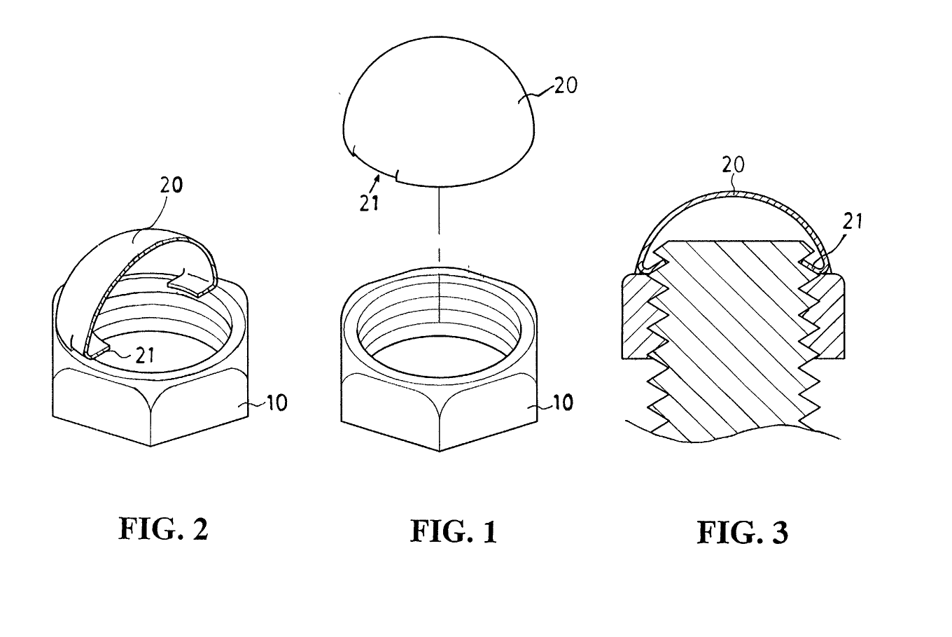

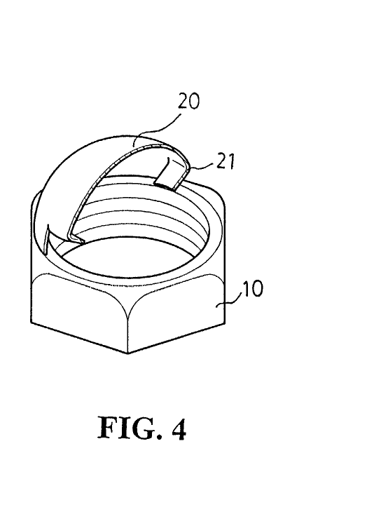

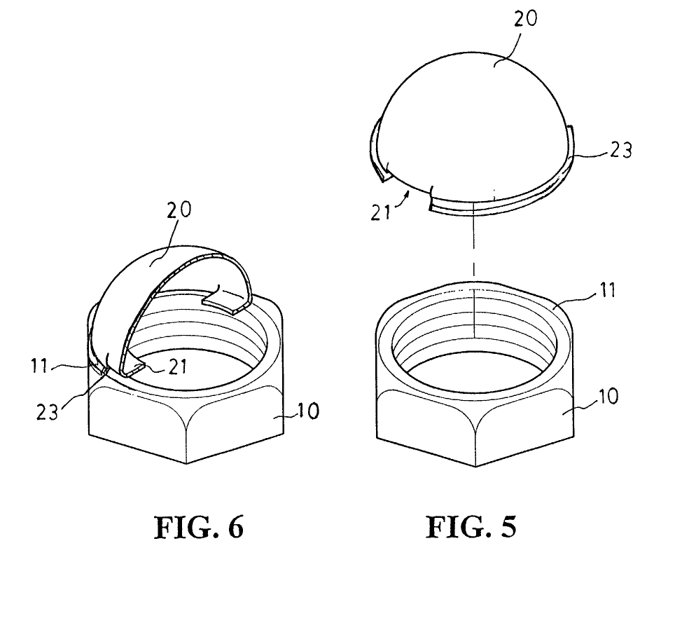

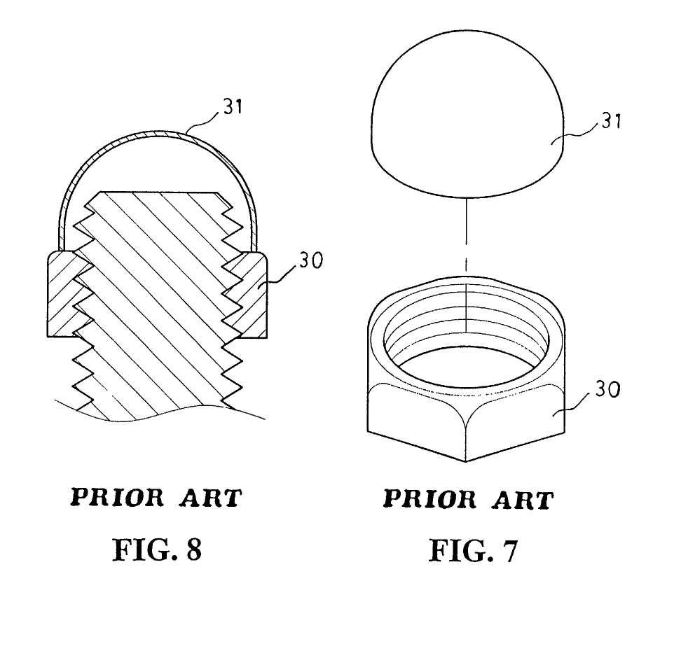

Referring to FIGS. 1 to 3, the loose prevention pocket nut structure comprises a screw nut body 10 and a nut cap 20 formed from a punched metallic plate and to be mounted to the external circumferential edge of the nut body 10. The nut cap 20 is of a disc-like shape or a semi-spherical shape, and the circumferential edge of the nut cap 20 is bent inward to form an engaging plate 21 and the nut cap 20 sits onto the circumferential edge of the nut body 10 with the engaging plate 21 formed into a hook-like edge. As shown in FIG. 4, the engaging plate 21 has a sloping and points toward the center of the nut body 10. The nut cap 20 and the screw nut body 10 are then placed in a mold and then this combined structure is proceeded to a welding process to combine the two components into one unit as the loose prevention pocket nut structure.

As shown in FIG. 3, after the locking end of a bolt 22 is mounted to the nut body 10, the engaging plate 20 will engage with the threads of the bolt 22. Due to the inclined sloping (curved upward) of the engaging plate 21, the engaging plate 21 is firmly secured with the bolt 22 without dislocation. In addition to the welding method, the bottom circumferential edge of the nut cap 20 is provided with an end plate 23 and the top edge of the nut body 10 is provided with a securing protruded ring 11 to mount the nut cap 20.

In accordance with the loose prevention pocket nut structure, there are advantages as compared to the recently available nut cap.

1) The manufacturing process is simple and the production is fully automatic. Molding process is employed and partial melting and welding process can be carried out automatically without using skilled laborer, and the rigidity of the product is of economic value.

2) The process of combination of components is safe. The fully automatic welding process provides stable and quality product.

3) Low cost of production and the rate of consistent production is rapid.

As the entire manufacturing process can be operated automatically, and the nut cap 20 and the screw nut body 10 are available in big bulk. Thus, the cost of production can be lowered and the process of manufacturing is fast, which provided economical benefits to the manufacturer.

4) Aesthetic appearance. The combination of the nut cap 20 and the screw nut body 10 is lightweight and has a cute appearance, a post-treatment process is not required, and therefore, the finished product has an aesthetic appearance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A loose prevention pocket nut structure comprising a screw nut and a nut cap formed from a punched metal sheet, characterized in that the bottom edge at the circumference of the nut cap is provided with an engaging plate for directly combine with the top edge of the screw nut within a mold to proceed to a mounting process such that the nut cap and the screw nut are formed integrally as a loose prevention pocket nut structure, thereby the protruded engaging plate secures with the bolt after the bolt is positioned with the screw nut.

2. A loose prevention pocket nut structure as set forth in claim 1, wherein the engaging plate is divided into a plurality of plates of equal sections.

3. A loose prevention pocket nut structure as set forth in claim 1, wherein the engaging plate is inclined at an angle (slope) facilitating combination with the screw nut.

4. A loose prevention pocket nut structure as set forth in claim 1, wherein the nut cap and the top end of the screw nut body are directly combined by melting and welding process.

5. A loose prevention pocket nut structure as set forth in claim 1, wherein the bottom end plate of the nut cap is extended and bent horizontally to facilitate mounting with the protruded top edge of the screw nut.
